(19) United States
(12) Patent Application Publication
(10) Pub. No.: US 2018/0252383 A1
(43) Pub. Date: Sep. 6, 2018

(54) HEAT SINK DEVICE FOR A MOTOR VEHICLE LIGHTING MODULE

(71) Applicant: VALEO VISION, Bobigny Cedex (FR)

(72) Inventors: Eric STEFURA, Bobigny Cedex (FR); Olivier-Sebastien LESAFFRE, Bobigny Cedex (FR); Huy-Cuong NGUYEN, Bobigny Cedex (FR); Olivier BADIA, Bobigny Cedex (FR); Erwan LE-DEVEHAT, Bobigny Cedex (FR); Eddie SAUSSET, Reims (FR)

(73) Assignee: VALEO VISION, Bobigny Cedex (FR)

(21) Appl. No.: 15/759,967

(22) PCT Filed: Sep. 9, 2016
(86) PCT No.: PCT/EP2016/071379

§ 371 Date: Mar. 14, 2018

(30) Foreign Application Priority Data
Sep. 14, 2015 (FR) 1558520

(51) Int. Cl. F21S 45/47; F21S 45/49; F21V 29/76; F21V 23/00; F21V 31/00

(52) U.S. Cl. CPC F21S 45/47; F21S 45/49; F21V 31/005; F21V 23/004; F21V 29/763

(57) ABSTRACT

A heat sink device for a motor vehicle lighting module made of stamped aluminum and ensures good thermal conductivity. The arrangement of the cooling fins of the device is such that the device is able to be installed in various orientations, while at the same time ensuring good dissipation of the heat produced by a printed circuit board attached to the device.

The invention relates to the field of lighting and light signaling, in particular for motor vehicles.

In the field of lighting and light signaling for motor vehicles, it is becoming increasingly common to use light sources based on light-emitting semiconductor components, for example light-emitting diodes, LEDs. An LED component emits light rays when a voltage with a value that is at least equal to a threshold value, referred to as direct voltage, is applied to its terminals.

In a known manner, one or more LEDs of a lighting module for a motor vehicle are supplied with power via power supply control means, which comprise converter circuits. The power supply control means are configured to convert an electric current of a first magnitude, for example delivered by a current source of the motor vehicle, such as a battery, to a load current having a second magnitude that is different from the first. The load current generally has a constant magnitude.

It is becoming increasingly common to integrate a plurality of motor vehicle lighting functions, for example the daytime running light (DRL) function, the high-beam light function, or other functions, into one and the same lighting module. As a result, the number of converters per module, and the heat that these components produce in the module, increase. There is therefore a need for efficient heat dissipation means. In view of the volume constraints imposed by the restricted space of a lighting module for a motor vehicle, it is nevertheless important for a heat sink to have compact dimensions and to be lightweight.

One aim of the invention is to propose a solution that overcomes the abovementioned problem. In particular, the invention proposes a lightweight heat sink device with high thermal conductivity and that is capable, in preferred embodiments, of being installed in a plurality of orientations, while at the same time ensuring good dissipation of the heat produced by the electronic components of a lighting module for a motor vehicle.

One subject of the invention is a heat sink device for a motor vehicle lighting module. The device comprises a base intended to receive, on a first face, a printed circuit board and comprises heat dissipation means on an opposite second face. The device is noteworthy in that the heat dissipation means comprise cooling fins that are formed by folds of at least one metal sheet, the heat dissipation fins being joined to the base by way of an attachment between at least one of the folds and the base.

The base may preferably form a main heat sink of the device.

The base may preferably be made of stamped aluminum. The base may advantageously have a generally flat geometry. It may preferably have a generally rectangular contour. The base may preferably be intended to receive a printed circuit board on one of its faces. The printed circuit board may comprise a circuit for controlling the supply of electric power to light sources of the lighting module, which circuit is able in particular to control the supply of electric power to these light sources so as to selectively implement a plurality of lighting functions, such as for example high-beam lighting, low-beam lighting, a daytime running light or a position light.

The cooling fins may preferably be made of aluminum.

The metal sheet may preferably have a thickness of less than 1 mm, preferably of 0.6 mm. The dissipation fins may preferably be formed by one or more clad and knurled aluminum sheets.

The height of the cooling fins with respect to the base may preferably be between 15 mm and 25 mm.

The base and/or the cooling fins may preferably have a thermal conductivity of between 180 and 230 W/(m·K).

The heat dissipation fins may preferably extend in at least two different directions that are parallel to the base.

The device may preferably comprise a plurality of cooling fins, of which at least two groups of fins extend in two directions that are perpendicular to one another.

Said plurality of fins may comprise a first group of fins extending at the periphery of the base, along two first edges that are parallel and opposite the base, and a second group of fins extending at the periphery of the base, along two second edges that are parallel and opposite the base, and that are in particular perpendicular to the first edges. As the case may be, the plurality of fins may comprise a third group of fins extending in a central region of the base and in a direction parallel to that of the first group.

The device may preferably comprise a plurality of cooling fins that extend radially in a plurality of directions starting from a central portion of the base.

The device may preferably comprise a thermal interface positioned between the cooling fins and the base, for example made of silicone.

The cooling fins may preferably be bonded to the base of the device. The bonding may be achieved using a polymerization adhesive in a polymerization oven. The adhesive may preferably be an adhesive with high thermal conductivity.

As an alternative, the cooling fins may be attached to the base by brazing. The brazing may preferably be carried out by means of aluminum oxide.

The base may preferably comprise, on its first face, crimping studs that are intended for attaching a printed circuit board to this face. The crimping studs may preferably be formed by stamping.

The device may furthermore comprise a cover made of stamped aluminum, intended to be attached in a sealtight manner to the first face of the base. The thermal conductivity of the cover may preferably be between 180 and 230 W/(m·K).

The cover may preferably be attached to the base by way of a gasket. The gasket may for example be made of rubber.

The cover may preferably comprise an aperture allowing access to the inside of the device, that is to say to the space intended to receive a printed circuit board. The aperture makes it possible for example to produce an electrical connection from the outside of the device to the printed circuit board.

The device may preferably comprise a protective grating, preferably made of plastic, for covering the cooling fins.

Another subject of the invention is a lighting module for a motor vehicle, comprising at least one semiconductor element-based light source and a printed circuit board comprising a circuit for controlling the supply of power to the light source(s). The lighting module is noteworthy in that the printed circuit board is attached to a heat sink device of the module, the device being in accordance with the invention.

The base of the device may preferably include means for attaching the device in the module.

The printed circuit board may preferably be covered in a sealtight manner by a cover of the heat sink device.

The provisions of the invention are beneficial in that they make it possible to propose a compact and lightweight heat sink device that nevertheless has a significant heat dissipation capability. This is due to the use of high-conductivity aluminum that is stamped and/or folded to produce the components of the device. In comparison with known solutions that use injected aluminum comprising a high percentage of additives, it has been possible to observe production cost savings of around 30% and weight reductions of around 40%. When the fins are bonded to the base of the heat sink device using a polymerization adhesive, the bonding step is able to be performed together with the bonding of the printed circuit board. The arrangement of the fins in a plurality of directions ensures that air is able to flow between the fins independently of the orientation and of the position of the device within a lighting module for a motor vehicle. This improves the design freedom for such a module, while at the same time ensuring good dissipation of the heat produced by the active components of the module. The heat dissipation capability may be adjusted by tailoring the dimensions of the fins, in particular their height with respect to the base of the device.

Other features and advantages of the present invention will be better understood with the aid of the description and the drawings, in which:

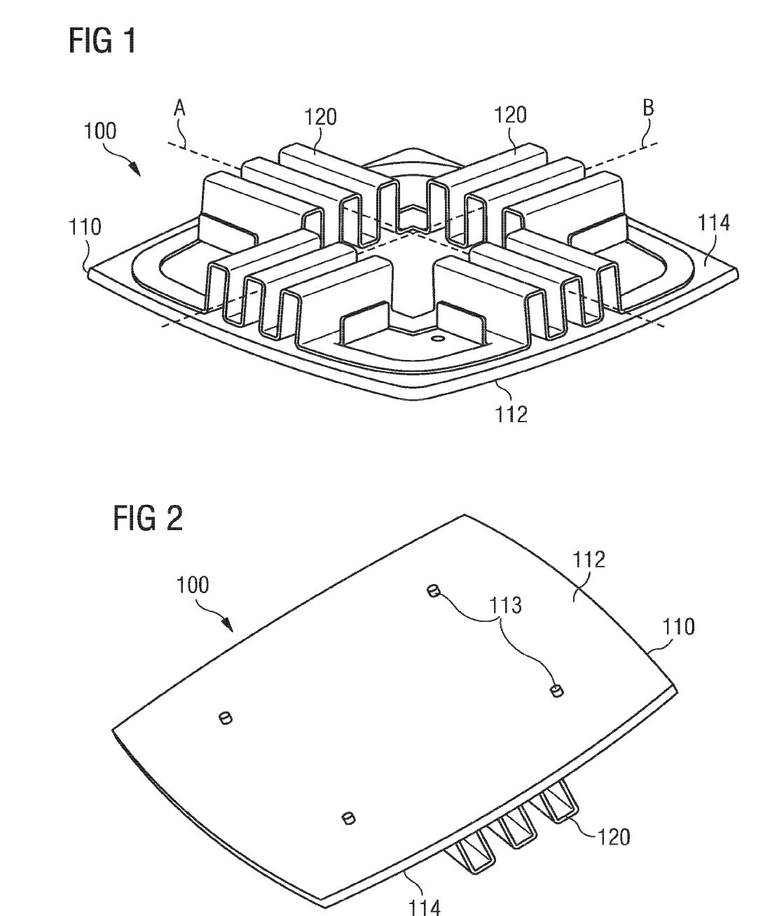

FIG. 1 is a perspective depiction from below of a device according to one preferred embodiment of the present invention;

FIG. 2 is a perspective depiction from above of a device according to one preferred embodiment of the present invention;

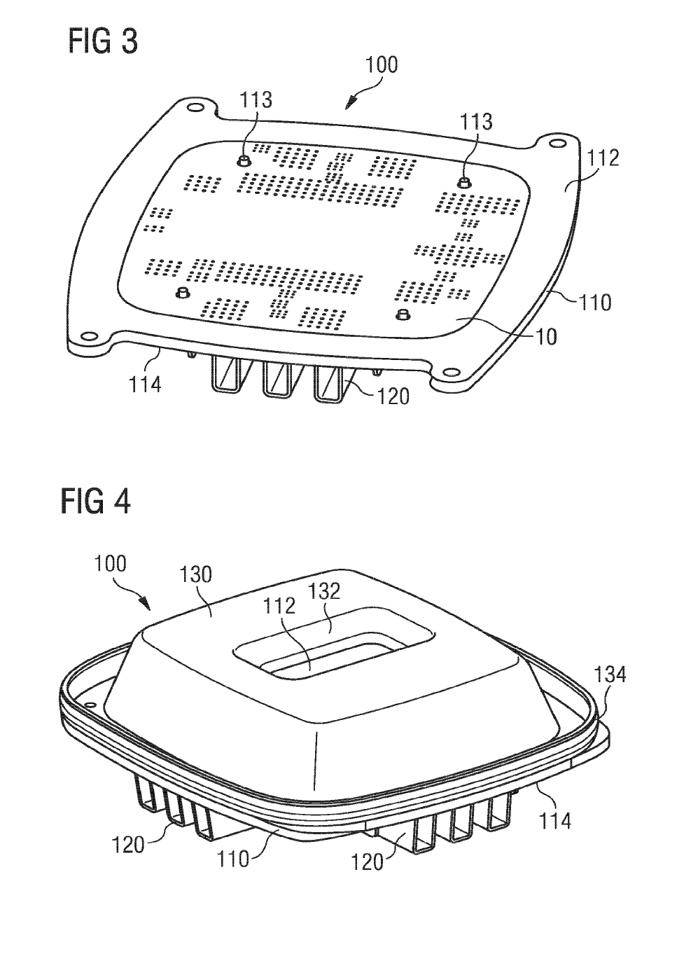

FIG. 3 is a perspective depiction from above of a device according to one preferred embodiment of the present invention, including a printed circuit board;

FIG. 4 is a perspective depiction from above of a device according to one preferred embodiment of the present invention, including a cover;

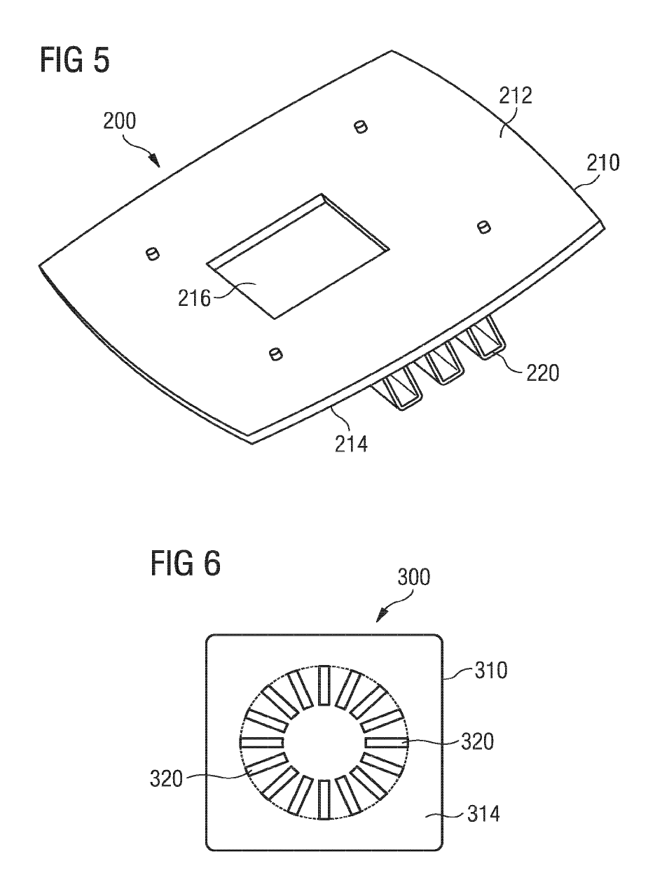

FIG. 5 is a perspective depiction from above of a device according to one preferred embodiment of the present invention;

FIG. 6 is a schematic depiction of a view from below of a device according to one preferred embodiment of the present invention.

In the following description, similar reference numerals will be used to describe similar concepts across the various embodiments of the invention. Thus, the numerals 100, 200, 300 describe a heat sink device in three different embodiments according to the invention.

Unless specified otherwise, technical features that are described in detail for one given embodiment may be combined with the technical features that are described in the context of other embodiments described by way of non-limiting example.

FIG. 1 shows a heat sink device 100 for a motor vehicle lighting module according to a first exemplary embodiment of the invention. The device comprises a base 110 with a generally flat geometry, which base is preferably made of substantially pure aluminum and has a thermal conductivity of between 180 and 230 W/(m·K). In the example illustrated, the base has a contour of generally rectangular shape. The base forms a main heat sink element of the device. A first face 112, shown directed downward, is intended to receive a printed circuit board, not illustrated. The printed circuit board may for example comprise light sources of the lighting module. This may involve light sources based on semiconductor components, for example light-emitting diodes, LEDs. As an alternative, the printed circuit board may comprise a circuit for controlling the supply of electric power to such light sources. The converters of such a circuit, such as the light sources, generally generate significant heat when they operate, which heat the device 100 has to be able to dissipate.

A second face 114, opposite the first face 112 and illustrated directed upward, comprises cooling fins 120 that are joined to the base by way of an attachment between at least one of the folds and the base. In the example shown and according to one preferred embodiment, the fins extend in at least two directions that are different but parallel to the plane of the base 110, so as to create air flow channels or grooves. In the example shown, these are two directions A, B that are generally perpendicular to one another. The cooling fins 140 are formed by folds of a metal plate. The plate preferably has a thin thickness of less than one millimeter, for example of 0.6 mm. Advantageously, it is also made of aluminum and has a high thermal conductivity of between 180 and 230 W/(m·K). The dissipation fins may be formed by one or more clad and knurled aluminum sheets. The height of the folds is chosen depending on the intended application. A greater height of the folds implies a larger heat exchange area of the fins with respect to the ambient air, and therefore a better heat dissipation capability of the device. The height of the folds may by way of example be between 15 and 25 mm. The cooling fins are attached to the face 114 of the base 110 in such a way as to ensure good mechanical strength and a good thermal link between the two elements. The link is preferably produced by bonding using a polymerization adhesive that is cured when the device is put into a polymerization oven. As an alternative, other attachments between the fins 120 and the base 110 may be contemplated without otherwise departing from the scope of the present invention, in particular an attachment by brazing the two components in question. As shown in FIG. 1, a plurality of groups of fins, two in each of the directions A and B, may be folded from one and the same aluminum sheet. As an alternative, each of the groups, or each of the fins, may be folded from a dedicated aluminum sheet. A protective grating, not illustrated, preferably made of plastic, may be provided so as to cover the cooling fins, in order to protect them upon the occurrence of any mechanical shocks.

FIG. 2 shows the first face 112, which is opposite the face 114 of the base 110 of the device 100. This face is intended to receive a printed circuit board that comprises heat-producing active electronic elements. In the example shown, the face 112 comprises crimping studs 113 that are intended to interact with holes that are provided in the substrate of a printed circuit board for this purpose. The crimping studs 113 are preferably formed by stamping of the plate made of aluminum that forms the base 110. To guarantee this effect, it is necessary to provide a thickness of at least 3 to 4 mm for the base. FIG. 3 shows by way of example a printed circuit board 10, without illustrating the electronic components thereof, held by the studs 113. The crimping makes it possible to ensure good mechanical strength and good thermal contact between the substrate of the printed circuit board and the base 110, in order to guarantee the exchange of heat between the two elements. As an alternative or in addition to the crimping, the printed circuit board may be bonded using a thermally conductive adhesive, for example a polymerization adhesive, on the face 112 of the base 110.

Heat is first of all exchanged between the printed circuit board, on which the heat is produced, and the base 110 of the device 100. Next, through the thermal link between the base 110 and the cooling fins 120, the heat travels to said cooling fins. The cooling fins have a large heat exchange area with the ambient air, which makes it possible to dissipate the heat.

The illustration of FIG. 4 once again takes up the device 100 comprising the base 110, on one face 114 of which base the cooling fins 120 are attached. The opposite face 112 of the base 110 is covered by a cover 130. The cover protects the printed circuit board that it covers on the face 112 from mechanical shocks and from possible electromagnetic interference. It may also contribute to the overall heat dissipation capability of the device. To this end, it is advantageous for the cover 130 to be formed by a plate made of lightweight metal, such as aluminum. The shape of the plate is obtained by stamping using a suitable tool. The variant of aluminum used preferably has a thermal conductivity of between 180 and 230 W/(m·K). The lower edge of the cover may, in a known manner, interact with the edge of the base 110 in order to link the two elements. Other mechanical linking means, such as crimping, and preferably also thermal linking means, are known per se in the art, and implementing them is within the scope of those skilled in the art. In order to guarantee the sealtightness of the link between the base 120 and the cover 130, a gasket 134, as illustrated in FIG. 4, manufactured for example from rubber, may be installed at the joint. In the example shown, the cover comprises an aperture 132 allowing access to the inside of the device, that is to say to the printed circuit board received on the face 112 of the device. The aperture 132 makes it possible for example to produce an electrical connection from the outside of the device to the printed circuit board.

FIG. 5 shows another embodiment of the heat sink device 200 according to the invention. The device comprises a base 210 with a generally flat geometry, which base is preferably made of aluminum and has a thermal conductivity of between 180 and 230 W/(m·K). A first face 212, shown directed upward, is intended to receive a printed circuit board, not illustrated. A second face 214, opposite the first face 212 and illustrated directed downward, comprises cooling fins 220 that extend in at least two directions that are different but parallel to the plane of the base 210. The face 212 has the particular feature that a recessed portion 216 has been produced by stamping of the base 210. Such a configuration is beneficial when the heat sink device 200 is intended to house therein a printed circuit board that comprises electronic components that are mounted on these two flat surfaces. When the printed circuit board is received on the face 212, the electronic components that are mounted on that face of the printed circuit board facing the face 212 are then housed in the recessed portion 216. Alternative geometries may obviously be provided according to the same principle and produced by suitable stamping, without otherwise departing from the scope of the present invention.

FIG. 6 shows a schematic view from above of an additional embodiment of the heat sink device 300 according to the invention. The face 314 of the base 310 is shown. This is the face to which the cooling fins 320 are attached. In comparison with the previous examples, an alternative arrangement of the cooling fins is illustrated by way of example. The fins 320 extend radially from a central portion of the base 310, so as to form a star-shaped or circular structure. Each pair whose cooling fins are radially opposite about the center is oriented in one direction. Other geometries for arranging the cooling fins are able to be contemplated. A larger number of directions in which the cooling fins extend generally implies increased flexibility in terms of the possibilities for positioning and orienting the device 300 within a lighting module. With a larger number of ambient air flow directions, the probability of a heat exchange between the cooling fins and the ambient air is generally higher.

1. A heat sink device for a motor vehicle lighting module, comprising a base intended to receive, on a first face, a printed circuit board and comprising heat dissipation means on an opposite second face, wherein the heat dissipation means comprise cooling fins that are formed by folds of at least one metal sheet, the heat dissipation fins being joined to the base by way of an attachment between at least one of the folds and the base.

2. The device as claimed in claim 1, wherein the base is made of stamped aluminum.

3. The device as claimed in claim 1, wherein the cooling fins are made of aluminum.

4. The device as claimed in claims 1, wherein the metal sheet has a thickness of less than 1 mm.

5. The device as claimed in claim 1, wherein the base and/or the cooling fins have a thermal conductivity of between 180 and 230 W/(m·K).

6. The device as claimed in claim 1, wherein the heat dissipation fins extend in at least two different directions that are parallel to the base.

7. The device as claimed in claim 6, wherein the device comprises a plurality of cooling fins, wherein at least two groups of fins extend in two directions that are perpendicular to one another.

8. The device as claimed in claim 6, wherein the device comprises a plurality of cooling fins that extend radially in a plurality of directions starting from a central portion of the base.

9. The device as claimed in claim 1, wherein the device includes a thermal interface positioned between the cooling fins and the base.

10. The device as claimed in claim 1, wherein the base comprises, on its first face, crimping studs that are intended for attaching a printed circuit board to this face.

11. The device as claimed in claim 1, wherein the device comprises a cover made of stamped aluminum and intended to be attached in a sealtight manner to the first face of the base.

12. A lighting module for a motor vehicle, comprising at least one semiconductor element-based light source and a printed circuit board comprising a circuit for controlling the supply of power to the light source(s), wherein the printed circuit board is attached to a heat sink device of the module, the device being as claimed in claim 1.

13. The lighting module as claimed in claim 12, wherein the printed circuit board is covered in a sealtight manner by a cover of the heat sink device.

14. The device as claimed in claim 2, wherein the cooling fins are made of aluminum.

15. The device as claimed in claim 2 wherein the metal sheet has a thickness of less than 1 mm.

16. The device as claimed in claim 2 wherein the base and/or the cooling fins have a thermal conductivity of between 180 and 230 W/(m·K).

17. The device as claimed in claim 2, wherein the heat dissipation fins extend in at least two different directions that are parallel to the base.

18. The device as claimed in claim 7, wherein the device comprises a plurality of cooling fins that extend radially in a plurality of directions starting from a central portion of the base.

19. The device as claimed in claim 2, wherein the device includes a thermal interface positioned between the cooling fins and the base.

20. The device as claimed in claim 2, wherein the base comprises, on its first face, crimping studs that are intended for attaching a printed circuit board to this face.
